(19) United States
(12) Patent Application Publication
(10) Pub. No.: US 2026/0340132 A1
(43) Pub. Date: Oct. 29, 2026

(54) COMPUTER SYSTEM AND INFORMATION PROCESSING METHOD

(71) Applicant: Hitachi, Ltd., Tokyo (JP)

(72) Inventor: Keisei FUJIWARA, Tokyo (JP)

(21) Appl. No.: 19/537,739

(22) Filed: Feb. 12, 2026

(30) Foreign Application Priority Data
Apr. 24, 2025 (JP) 2025-072688

(51) Int. Cl. G06F 21/57; G06F 9/50; G06F 21/60; G06F 21/72

(52) U.S. Cl. CPC G06F 21/57; G06F 9/5027; G06F 9/5083; G06F 21/575; G06F 21/602; G06F 21/72

(57) ABSTRACT

A computer 30 of a computer system 1 has a plurality of processors 310, 360, 370, memories 320, 361, 371 provided correspondingly to the plurality of processors, and a network interface 340 coupled to the plurality of processors, and when executing block processing on encrypted data, executes the block processing in parallel in a trusted area, based on the designated processing entity and the parallel number, aggregates and encrypts execution results, and outputs them to a next predetermined processor.

### CROSS-REFERENCE TO RELATED APPLICATION

The present application claims priority from Japanese application JP2025-072688, filed on Apr. 24, 2025, the content of which is hereby incorporated by reference into this application.

### BACKGROUND

The present invention relates to a computer system and an information processing method.

In recent years, new value is being created by linking diverse information, as can be seen in, for instance, cooperation between public services and private services. As one of important means for creating new value by linking diverse information, machine learning such as DNN (Deep Neural Network) and generative AI is attracting attention. Infrastructures that enable various companies and organizations to easily utilize machine learning are also being provided using publicly available cloud services and the like that can be used inexpensively.

On the other hand, strengthening of regulations for the purpose of protecting privacy is progressing worldwide. Therefore, technology is required that implements processing by machine learning or the like while keeping confidential information owned by data holders such as hospitals and banks that hold customer information confidential.

It has also been proposed to implement utilization in a state where confidential information is kept confidential by enabling specific processing while data is encrypted. However, processing that can be executed by conventional technology is limited to basic processing such as search and order comparison, and there is a limit to the degree of freedom of processing. Therefore, technology is required that can correspond to advanced information processing that requires a high degree of freedom of processing, for example, advanced information processing using machine learning such as DNN and generative AI, LLM (Large Language Model).

In recent years, TEE (Trusted Execution Environment) functions are installed in CPU (Central Processing Unit) or GPU (Graphical Processing Unit). Furthermore, there is also technology that provides TEE functions in FPGA (Field Programmable Gate Array). The TEE function is considered to be effective for processing confidential information. The TEE function is a function that provides a trusted area where information cannot be read even if administrator authority of OS (Operating System) running on a computer is taken away. By decrypting and processing encrypted data within the trusted area, safe and advanced information processing becomes possible.

Technology that uses the trusted area of the TEE function for machine learning is known (Japanese Patent No. 7544681). Japanese Patent No. 7544681 discloses a method for confidential execution of a machine learning model and a machine learning application using a trusted execution environment (trusted area) provided by the TEE function.

The technology described in Japanese Patent No. 7544681 is a computer system including at least one computer, wherein the at least one computer has a processor, a memory coupled to the processor, and a network interface coupled to the processor, the processor has a function for setting a trusted area that is secured in security and logically isolated in the memory, the at least one computer accepts an execution request for processing that includes a plurality of operations of block processing on encrypted data in which data including confidential information is encrypted, when executing one operation of the block processing, determines whether decryption of the encrypted data is necessary in the block processing, when decryption of the encrypted data is not necessary in the block processing, executes the block processing using an area different from the trusted area, and when decryption of the encrypted data is necessary in the block processing, executes the block processing using the trusted area.

### SUMMARY

Japanese Patent No. 7544681 does not disclose technology for linking a plurality of trusted areas. For example, a configuration or procedure for safely and efficiently linking a trusted area of TEE provided in a CPU and a trusted area of TEE provided in an accelerator such as GPU or FPGA, which has appeared in recent years, to execute a machine learning application or the like is not disclosed.

Therefore, the present disclosure provides a computer system and an information processing method that enable a plurality of processors to perform information processing by linking trusted areas corresponding to the processors respectively.

In order to solve the above problem, a computer system according to one aspect of the present invention is a computer system including at least one computer, wherein the at least one computer has a plurality of processors, memories provided correspondingly to the plurality of processors, and a network interface coupled to the plurality of processors, the plurality of processors have a function for setting a trusted area that is secured in security and logically isolated in a corresponding memory among the plurality of memories, the at least one computer accepts an execution request for processing that includes a plurality of operations of block processing on encrypted data in which data including confidential information is encrypted, when executing one operation of block processing, sets as a processing entity a predetermined processor designated in the block processing from the plurality of processors, executes the block processing in parallel in the trusted area of the processing entity with a parallel number, based on the processing entity and the parallel number, when each parallel execution ends, aggregates and encrypts each execution result in the trusted area of the processing entity, designates as a next predetermined processor a processor related to block processing to be executed next among the plurality of operations of block processing, and outputs each execution result aggregated to the next predetermined processor.

According to the present invention, a plurality of trusted areas can be linked to execute block processing in parallel.

### BRIEF DESCRIPTION OF THE DRAWINGS

FIG. 1 is an explanatory diagram showing the overall configuration of a confidential information processing system according to the present embodiment;

FIG. 2 is a diagram showing a hardware configuration of the confidential information processing system;

FIG. 3 is a sequence diagram showing an example of a flow of provision of a confidential information processing service;

FIG. 4 is a block diagram showing a functional configuration of a server 30;

FIG. 5 is an explanatory diagram of a layer processing information table; and

FIG. 6 is a flowchart showing an example of confidential information processing.

### DETAILED DESCRIPTION OF THE EMBODIMENT

Hereinafter, embodiments of the present invention will be described using drawings. However, the present invention is not to be construed as being limited to the description content of the embodiments shown below. It is easily understood by those skilled in the art that specific configurations can be changed without departing from the spirit or gist of the present invention.

In the configuration of the invention described below, the same or similar configurations or functions are given the same reference numerals, and duplicate descriptions are omitted.

Notations such as "first", "second", "third", etc. in this specification and the like are attached to identify components, and do not necessarily limit numbers or order.

The present disclosure shows a system and method for performing information processing by linking trusted areas provided by a plurality of TEE functions. The present disclosure can be used for processing confidential information. The system and method of the present disclosure can safely exchange data between a plurality of trusted areas and can process confidential information safely and at high speed among the plurality of trusted areas.

In the following description, as a "computer system", a "confidential information processing system" that processes confidential information will be described as an example.

The computer system of the present disclosure can adopt, for example, the following configuration.

A computer system including at least one computer, wherein the at least one computer has a processor, a memory connected to the processor, and a network interface connected to the processor, the processor has a function for setting a trusted area that is secured in security and logically isolated in the memory, the at least one computer accepts an execution request for processing that includes a plurality of operations of block processing on encrypted data in which data including confidential information is encrypted, when executing one operation of the block processing, executes the block processing in parallel in the trusted area of the processing entity with the parallel number based on a processing entity and a parallel number designated in the block processing, and after each parallel execution ends, aggregates and encrypts each execution result in the trusted area of the processing entity and outputs it.

According to one aspect of the present disclosure, for example, by linking a plurality of trusted areas among trusted areas possessed by CPU, GPU, or FPGA, and encrypting parameter information in small portions, flexible parallel execution of large-scale parameters at the time of inference is realized. Therefore, in the present disclosure, safe data exchange and efficient execution can be realized using a plurality of trusted areas. Thereby, the present disclosure provides technology capable of executing a machine learning application safely and at high speed. Problems, configurations, and effects other than those described above will be clarified by the description of the following embodiments.

In the present disclosure, the plurality of processors include at least one general-purpose processor and at least one processor for specific processing.

The general-purpose processor is, for example, at least one of CPU or MPU (Micro Processing Unit), and the processor for specific processing is, for example, at least one of GPU, FPGA, and IPU (Infrastructure Processing Unit). The processor is not limited to the above examples.

### Embodiment 1

### 1-1. Configuration Example of Confidential Information Processing System

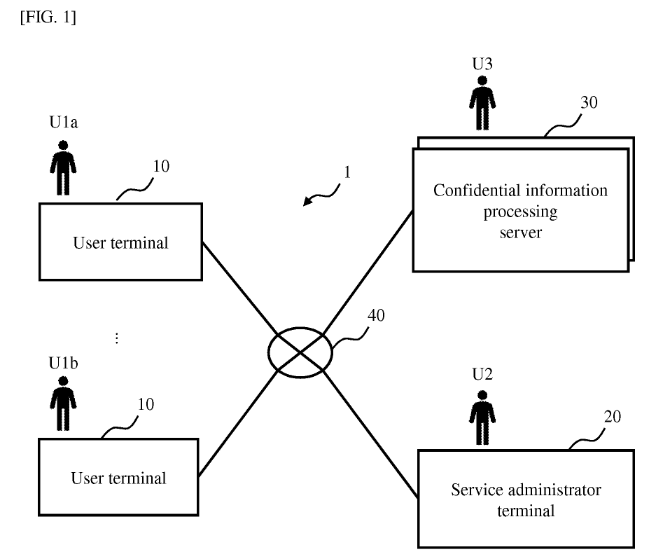

FIG. 1 is a block diagram showing a configuration example of a confidential information processing system 1 of Embodiment 1. The confidential information processing system 1 as a "computer system" receives data including encrypted confidential information from a service user (data holder) who holds confidential information such as personal information and corporate secrets. The confidential information processing system 1 processes the received data in a state where confidential information is kept confidential to the outside, and provides the processing result to the service user. Here, the outside is a concept including, for example, a cloud administrator and a service administrator.

The confidential information processing system 1 includes, for example, a user terminal 10, a server 30, and a service administrator terminal 20. The user terminal 10, the confidential information processing server 30, and the service administrator terminal 20 are connected to each other via a communication network 40 such as the Internet. Here, the communication network 40 is, for example, a communication network such as the Internet by wired communication or wireless communication, an intranet such as an in-house network, or a satellite line.

The user terminal 10 is a computer terminal used by a service user U1a who uses the confidential information processing service or a data holder U1b who provides data to the confidential information processing service. Note that the service user U1a and the data holder U1b may be the same. Hereinafter, the reference numerals of the service user U1a and the data holder U1b are omitted.

The data holder uses the user terminal 10 to encrypt data including confidential information and transmits it to the confidential information processing server 30. The service user uses the user terminal 10 to transmit a service use application and a processing execution request.

The service administrator terminal 20 is a computer terminal used by a service administrator who provides the confidential information processing service. The service administrator uses the service administrator terminal 20 to accept a use application for the confidential information processing service from a service user. Furthermore, the service administrator uses the service administrator terminal 20 to construct, operate, and manage the environment of the confidential information processing server 30.

When the confidential information processing server 30 receives an execution request for processing using data received from a service user, it executes processing in a state where data including confidential information is kept confidential to the outside, and transmits the processing result to the terminal 10 of the service user. Hereinafter, the confidential information processing server 30 may be abbreviated as server 30.

The confidential information processing system 1 may include a plurality of user terminals 10, may include a plurality of service administrator terminals 20, and may include a plurality of confidential information processing servers 30. When the confidential information processing system 1 includes a plurality of user terminals 10, the user terminal 10 that transmits confidential information and the user terminal 10 that uses the processing result may be different.

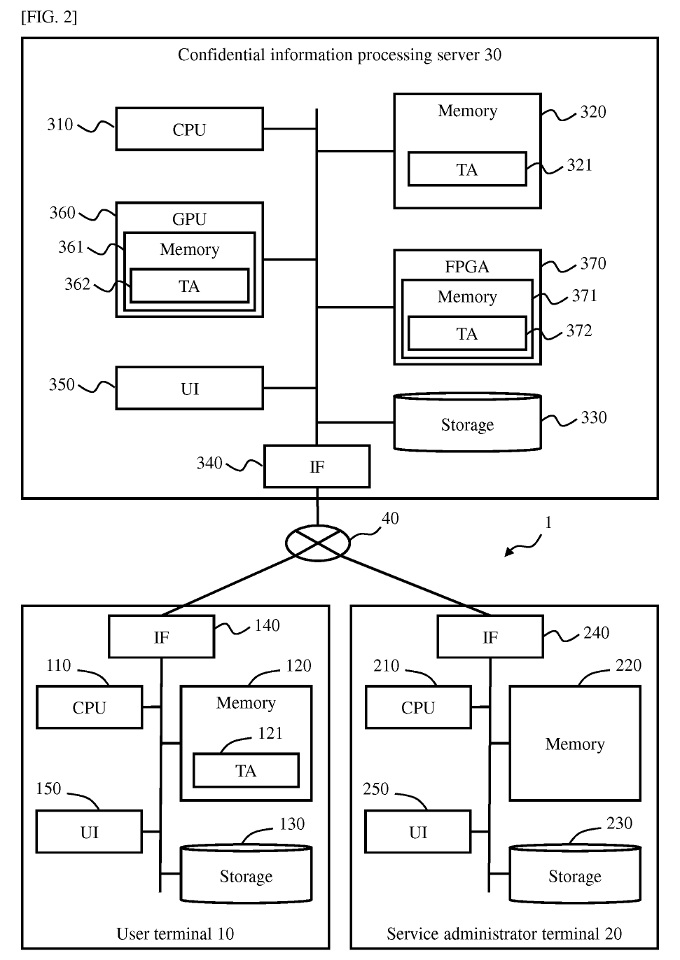

FIG. 2 is a block diagram showing a hardware configuration example of the confidential information processing system 1. Using FIG. 2, the hardware configuration of each of the user terminal 10, the service administrator terminal 20, and the server 30 will be described.

The user terminal 10 is, for example, a computer such as a personal computer, a smartphone, or a server device. The user terminal 10 includes, for example, a CPU 110, a memory 120, an auxiliary storage device 130, a network interface 140, and a user interface device 150 that are connected to each other by an internal communication line.

The CPU 110 is an example of an arithmetic device and executes a program stored in the memory 120. The memory 120 includes a ROM (Read Only Memory) which is a non-volatile storage element and a RAM (Random Access Memory) which is a volatile storage element. The ROM stores, for example, an invariable program such as BIOS (Basic Input/Output System). The RAM is a high-speed and volatile storage element such as DRAM (Dynamic Random Access Memory), and temporarily stores a computer program executed by the CPU 110 and data used when the computer program is executed.

The CPU 110 is a TEE-compatible CPU having a TEE function. The CPU 110 generates a trusted area 121 using the TEE function. In the figure, the trusted area is abbreviated as "TA". A trusted area is a hardware storage area provided in the memory 120 and is an area isolated from other areas. The trusted area 121 is assumed to have a small capacity (for example, 128 GB) relative to the total storage area of the memory 120. When the amount of memory use required for executing processing is larger than the capacity of the trusted area 121, the processing speed of processing using the area decreases due to occurrence of paging processing.

The trusted area 121 may be generated at the time of executing processing, or may be generated before the start of processing. Note that there is no need to particularly set a limit on the capacity of the trusted area 121.

The auxiliary storage device 130 is, for example, a large-capacity and non-volatile storage device such as a magnetic storage device (HDD: Hard Disk Drive) or flash memory (SSD: Solid State Drive). The auxiliary storage device 130 stores a computer program executed by the CPU 110 and data used when the computer program is executed. The computer program is read from the auxiliary storage device 130, loaded into the memory 120, and executed by the CPU 110. In the figure, the auxiliary storage device is abbreviated as "storage".

The user interface device 150 is a device that exchanges information with a user. The user interface device 150 includes an information input device and an information output device. The information input device is, for example, a keyboard, a pointing device, or the like. The information output device is, for example, a device such as a display or a printer that outputs the execution result of a computer program in a form that the user can visually recognize. In order to exchange information with a user, technology known as so-called VR (Virtual Reality), AR (Augmented Reality), MR (Mixed Reality), and XR (Extended Reality) may be used.

The network interface 140 controls communication with other devices according to a predetermined communication protocol. The network interface 140 may include, for example, a serial interface such as USB (Universal Serial Bus).

The computer program executed by the CPU 110 may be stored in advance in the non-volatile auxiliary storage device 130, which is a computer-readable non-transitory storage medium, or may be provided to the user terminal 10 from removable media (CD-ROM, flash memory, etc.), which is a non-transitory storage medium, or from a non-transitory storage device of another device via a network, and stored in the auxiliary storage device 130. The user terminal 10 may have an interface for reading data from removable media. This also applies to the service administrator terminal 20 and the server 30.

The service administrator terminal 20 is, for example, a computer such as a personal computer, a smartphone, or a server device. The service administrator terminal 20 includes, for example, a CPU 210, a memory 220, an auxiliary storage device 230, a network interface 240, a user interface device 250, and an input device 26 that are connected to each other by an internal communication line.

The description of the CPU 210, the memory 220, the auxiliary storage device 230, the network interface 240, and the user interface device 250 as hardware is the same as the description of the CPU 110, the memory 120, the auxiliary storage device 130, the network interface 140, and the user interface device 150 as hardware, respectively. However, the CPU 210 does not need to have a TEE function.

The server 30 is, for example, a computer such as a personal computer, a smartphone, or a server device. The server 30 includes, for example, a CPU 310, a memory 320, an auxiliary storage device 330, a network interface 340, a user interface device 350, a GPU 360, and an FPGA 370 that are connected to each other by an internal communication line such as a bus.

The description of the CPU 310, the memory 320, the auxiliary storage device 330, the network interface 340, and the user interface device 350 as hardware is the same as the description of the CPU 110, the memory 120, the auxiliary storage device 130, the network interface 140, and the user interface device 150 as hardware, respectively. However, the CPU 310 of the server 30 has a TEE function and can generate a trusted area 321 in the memory 320.

The GPU 360 has a TEE function and can generate a trusted area 362 in a memory 361. The GPU 360 can execute a computer program stored in the trusted area 362 while keeping it confidential from a privileged administrator of the server 30.

The FPGA 370 has a TEE function and can generate a trusted area 372 in a memory 371. The FPGA 370 can execute a computer program stored in the trusted area 372 while keeping it confidential from a privileged administrator of the server 30.

The server 30 does not need to include both the GPU 360 and the FPGA 370. The server 30 only needs to include a plurality of processors capable of using a trusted area. The server 30 only needs to include at least one general-purpose processor and at least one processor for specific processing (accelerator). For example, the server 30 may include at least one CPU 310 and at least one GPU 360. The server 30 may include at least one CPU 310 and at least one FPGA 370.

The server 30 may include at least one CPU 310, at least one GPU 360, and at least one FPGA 370. As a general-purpose processor, an MPU can also be used instead of a CPU.

As a processor for specific processing, an IPU can also be used. Therefore, in addition to the above combinations, the server 30 can include, for example, any one of a combination of MPU and GPU, a combination of MPU and FPGA, a combination of MPU and IPU, a combination of MPU and GPU and FPGA, a combination of MPU and GPU and IPU, a combination of MPU and FPGA and IPU, a combination of MPU and GPU and FPGA and IPU, a combination of CPU and IPU, a combination of CPU and GPU and IPU, a combination of CPU and GPU and FPGA and IPU, a combination of CPU and MPU and GPU, a combination of CPU and MPU and FPGA, a combination of CPU and MPU and IPU, a combination of CPU and MPU and GPU and FPGA, a combination of CPU and MPU and GPU and IPU, or a combination of CPU and MPU and GPU and FPGA and IPU.

In the present embodiment, a TEE function is used as a function for realizing processing in a safe area isolated on memory, but a different method may be adopted.

Part or all of processing executed by any one of the CPU 110, the CPU 210, the CPU 310, the GPU 360, or the FPGA 370 may be executed by hardware such as, for example, ASIC (Application Specific Integrated Circuit).

The user terminal 10, the service administrator terminal 20, and the server 30 may be realized as a computer system configured on a plurality of computers configured logically or physically. The user terminal 10, the service administrator terminal 20, and the server 30 may be realized as separate threads on the same computer, or may be realized as a virtual computer constructed using resources of a plurality of physical computers.

In the present embodiment, information used by the confidential information processing system 1 may be expressed by any data structure without depending on a data structure, and for example, a data structure appropriately selected from a list, a table, a database, or a queue can store information.

### 1-2 Flow Example of Provision of Confidential Information Processing Service by Confidential Information Processing System

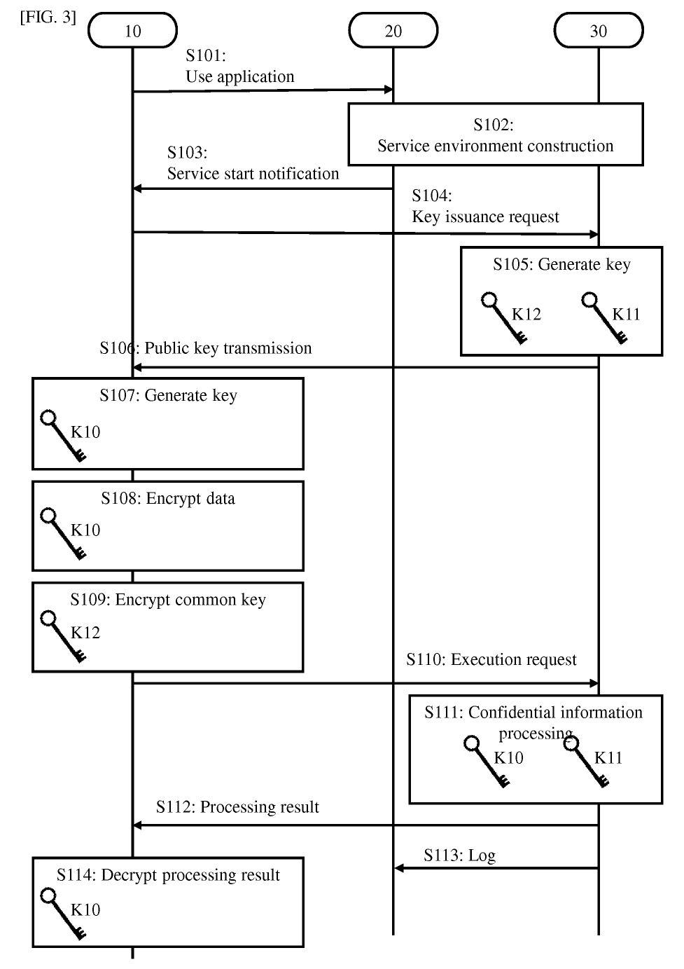

FIG. 3 is a sequence diagram showing an example of a flow of a confidential information processing service provided by the confidential information processing system 1.

The confidential information processing service provided by the confidential information processing system 1 will be described. The confidential information processing service is a service that provides advanced and security-secured information processing functions using the server 30 to service users by construction and operation management of the server 30 on the cloud by a service administrator.

The value provided by the confidential information processing service is to make computer resources on the cloud that are inexpensive and highly functional available to service users in a state where confidential information is kept confidential. By using the confidential information processing service, the service user does not need to purchase expensive computer and software resources, construct an environment, or perform operation management at a customer site. Thereby, the service user can obtain results of advanced information processing such as AI learning and AI inference without disclosing confidential information to a cloud administrator and a service administrator.

Hereinafter, an example of a flow of provision of the above-described confidential information processing service will be described with reference to FIG. 3.

The service user operates the user terminal 10 to transmit a use application for the confidential information processing service to the service administrator terminal 20 (S101).

The service administrator operates the service administrator terminal 20 to construct a service environment on the cloud (S102).

The service administrator uses the service administrator terminal 20 to execute construction of the server 30 and activation of the confidential information processing service on the server 30, and the like. Here, the cloud administrator is a privileged user in a data center of the cloud and monitors operation logs and the like of the service administrator on the cloud.

The service administrator operates the service administrator terminal 20 to transmit a start notification of the confidential information processing service to the user terminal 10 (S103).

The service user operates the user terminal 10 to transmit a key issuance request for encrypting confidential information to be transmitted to the server 30 to the server 30 (S104).

When the server 30 receives the key issuance request, it generates a key pair of public key encryption in the trusted area 321 (S105), holds a secret key K11 of the key pair in the trusted area 321, and transmits a public key K12 of the key pair to the user terminal 10 (S106). Here, it is assumed that the secret key K11 and the public key K12 are generated as a key pair.

The service user operates the user terminal 10 to generate a common key K10 used for encrypting/decrypting confidential information, processing content, or processing results (S107). The service user operates the user terminal 10 to encrypt, using the common key K10, confidential information and parameter information of an AI model including confidential information, which are included in data to be processed by the confidential information processing service (S108), and further encrypts the common key K10 using the public key K12 (S109). The service user operates the user terminal 10 to transmit an execution request including the encrypted data and the encrypted common key to the server 30 (S110).

The server 30 executes confidential information processing that decrypts and processes confidential information included in the received data within the trusted area 321, within the trusted area 362, or within the trusted area 372 (S111). The server 30 transmits a processing result encrypted using the common key K10 to the user terminal 10 (S112). The server 30 transmits an execution log and the like of the confidential information processing to the service administrator terminal 20 (S113).

The service user operates the user terminal 10 to decrypt the received processing result using the common key K10 (S114) and obtains a processing result of confidential information processing on data including confidential information.

### 1-3. Functional Configuration Example of Server 30 and Data Processing Example of Confidential DNN Processing

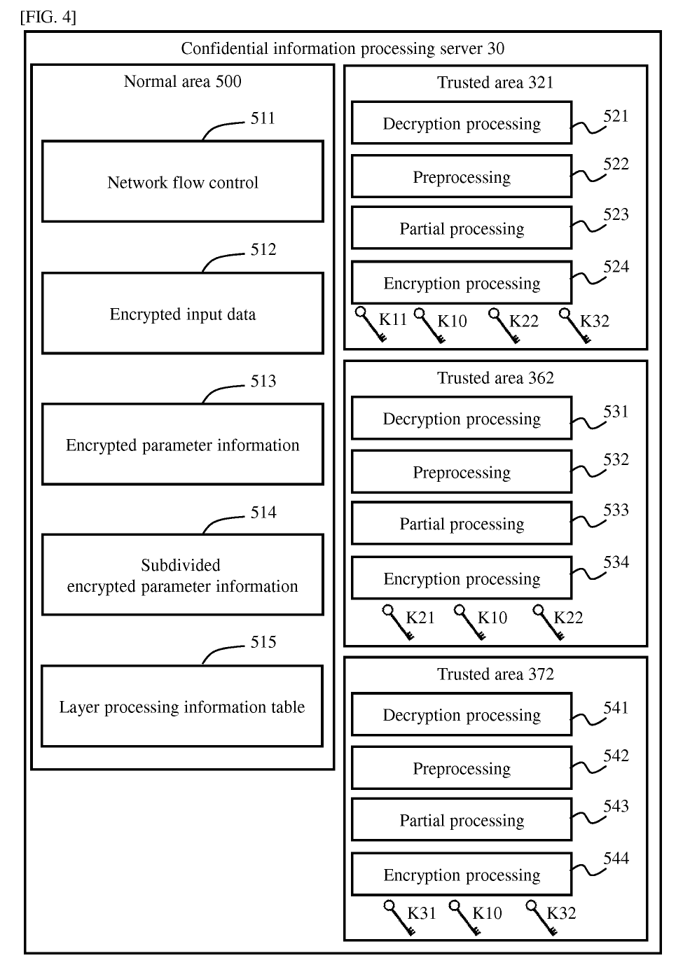

FIG. 4 is a block diagram showing an example of a functional configuration of the server 30 of Embodiment 1. As an example of confidential information processing, the functional configuration of the server 30 that executes confidential DNN processing will be described with reference to FIG. 4.

The server 30 includes, for example, a normal area 500 and trusted areas 321, 362, and 372 provided by the TEE function. The normal area 500 is used for performing high-speed processing by a normal CPU and memory and acceleration chips such as GPU and FPGA. The trusted areas 321, 362, and 372 are storage areas with high safety and isolation.

In the normal area 500, for example, a network flow control unit 511, encrypted input data 512, encrypted parameter information 513, subdivided encrypted parameter information 514, and a layer processing information table 515 are stored. In FIG. 4, "control unit" is abbreviated as "control", and "processing unit" is abbreviated as "processing".

The network flow control unit 511 is a part of machine learning (hereinafter, description will be given taking DNN as an example) processing with a multi-layer network structure such as DNN and LLM, and executes control processing of data flow of input and output of encrypted data based on network relationships between layers.

The encrypted input data 512 is encrypted input data that is an inference target of an AI model including confidential information transmitted by the service user terminal 10.

The encrypted parameter information 513 is parameter information of an AI model transmitted by the service user terminal 10, and includes a network configuration such as the number of layers of DNN or LLM, types of calculation processing of each layer, and weight values of each parameter. The encrypted parameter information 513 is stored in the auxiliary storage device 330 of the server 30, and the network flow control unit 511 reads it to the normal area 500 when necessary.

The subdivided encrypted parameter information 514 is a group of subdivided encrypted parameters obtained by decrypting the encrypted parameter information 513, which ranges from, for example, several GB to several TB, in the trusted area 321, subdividing it into small sizes (256 Bytes, etc.), and encrypting it.

By performing this subdivision processing in advance, the server 30 can perform parallel processing efficiently. That is, by performing subdivision processing in advance, the server 30 can divide encrypted parameters into substantially equal sizes without decrypting the encrypted parameters when dividing them to execute in parallel in multithread. Thereby, the server 30 can complete each multithread parallel execution processing at substantially the same time. Therefore, the server 30 can speed up AI execution processing and shorten the time to respond with a processing result to a customer.

The subdivided encrypted parameter information 514 is stored in the auxiliary storage device 330 of the server 30. The network flow control unit 511 reads the subdivided encrypted parameter information 514 from the auxiliary storage device 330 to the normal area 500 when necessary.

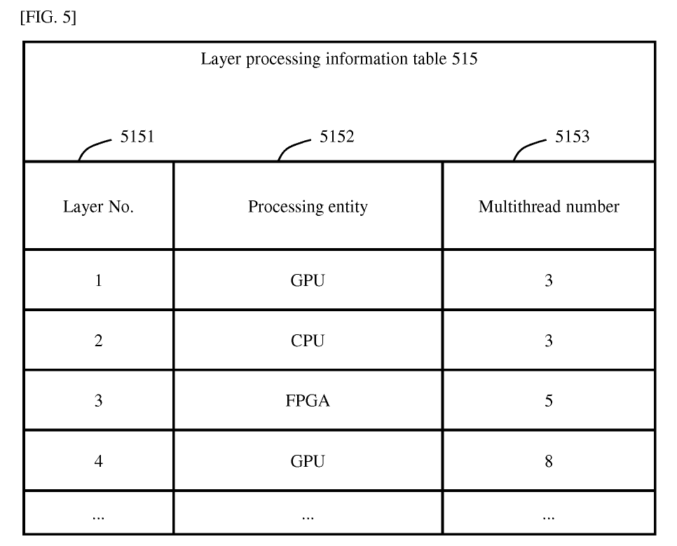

Details of the layer processing information table 515 will be described later in FIG. 5. To briefly explain first, the layer processing information table 515 is a table that records information about which of the CPU 110, GPU 360, and FPGA 370 executes processing of each layer of DNN or LLM, and how many parallel numbers (multithread numbers) each layer is executed with. The layer processing information table 515 is stored in the auxiliary storage device 330 of the server 30. The network flow control unit 511 reads the layer processing information table 515 from the auxiliary storage device 330 to the normal area 500 when necessary.

In the trusted area 321 generated in the memory 320, for example, a decryption processing unit 521, a preprocessing unit 522, a partial processing unit 523, an encryption processing unit 524, a common key K10, a secret key K11, a public key K22, and a public key K32 are stored.

The partial processing unit 523 executes processing of a layer of DNN or LLM. The decryption processing unit 521 decrypts the common key K10 encrypted by the public key K12 using the secret key K11 stored in the trusted area 321, and stores it in the trusted area 321. The encryption processing unit 524 encrypts a processing result output by the partial processing unit 523 using the common key K10 stored in the trusted area 321. Furthermore, the encryption processing unit 524 encrypts the common key K10 using a public key K22 corresponding to a secret key K21 of the trusted area 362 or a public key K32 corresponding to a secret key K31 of the trusted area 372.

In the trusted area 362 within the GPU 360, for example, a decryption processing unit 531, a preprocessing unit 532, a partial processing unit 533, an encryption processing unit 534, a common key K10, a secret key K21, and a public key K22 are stored. The partial processing unit 533 executes processing of a layer of DNN or LLM. The decryption processing unit 531 decrypts the common key K10 encrypted by the public key K22 using the secret key K21 stored in the trusted area 362, and stores it in the trusted area 362. The encryption processing unit 534 encrypts a processing result output by the partial processing unit 533 using the common key K10 stored in the trusted area 362.

In the trusted area 372 within the FPGA 370, for example, a decryption processing unit 541, a preprocessing unit 542, a partial processing unit 543, an encryption processing unit 544, a common key K10, a secret key K31, and a public key K32 are stored. The partial processing unit 543 executes processing of a layer of DNN or LLM. The decryption processing unit 541 decrypts the common key K10 encrypted by the public key K32 using the secret key K31 stored in the trusted area 372, and stores it in the trusted area 372. The encryption processing unit 544 encrypts a processing result output by the partial processing unit 543 using the common key K10 stored in the trusted area 372.

FIG. 5 shows an example of the layer processing information table 515. The layer processing information table 515 is composed of, for example, a layer number column 5151 indicating a layer number, a processing entity column 5152 indicating a processor that performs processing of that layer, and a multithread number column 5153 indicating a parallel degree of processing that executes that layer. For example, the first record of the layer processing information table 515 indicates that the processor that performs processing of the first layer of DNN or LLM is the GPU 360, and that partial processing of the first layer is executed in parallel by generating three multithreads. Each record information of the layer processing information table 515 is input to the layer processing information table 515 by a service administrator via the service administrator terminal 20 or by a service user via the user terminal 10.

When a service administrator or a service user manually sets a processing entity and a multithread number (number of parallel processing) in the layer processing information table 515, the processing entity and multithread number are selected according to the nature of layer processing. For example, for a layer that performs linear processing mainly for image processing, the GPU 360 is selected as the processing entity, and a large value is set for the multithread number. For a layer that performs linear processing mainly for text processing, the FPGA 370 is selected as the processing entity, and a large value is set for the multithread number. For a layer that performs non-linear processing that is not suitable for either the GPU 360 or the FPGA 370, the CPU 110 is selected as the processing entity, and the multithread number is set in consideration of the limited number of CPU cores of the CPU 310.

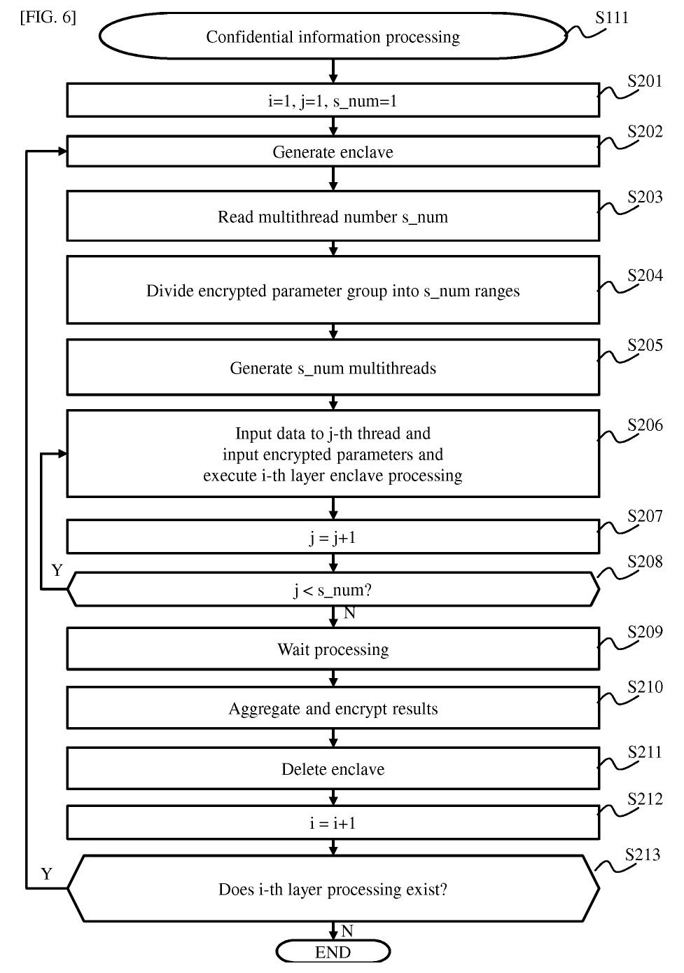

FIG. 6 is a flowchart showing an example of confidential information processing executed by the server 30. Hereinafter, an example of confidential information processing (DNN or LLM processing) executed by the server 30 will be described with reference to FIG. 6.

When the server 30 receives an execution request for processing including data encrypted using the common key K10 and the common key K10 encrypted using the public key K12, it executes confidential information processing described below.

When the network flow control unit 511 of the server 30 receives an execution request for processing, it initializes values of each of variable i, variable j, and variable s_num to 1 (S201). These variables i, j, and s_num are used for network flow control of DNN used in confidential DNN processing on encrypted data.

The network flow control unit 511 reads subdivided encrypted parameter information 514 of DNN used in confidential DNN processing from the auxiliary storage device 330 and stores it in the normal area 500. The network flow control unit 511 starts processing of network flow that performs confidential DNN processing based on the subdivided encrypted parameter information 514.

The network flow control unit 511 reads a processing entity (CPU, GPU or FPGA) of the i-th layer from the layer processing information table 515, and generates an enclave of layer processing of the i-th layer for the TEE of the read processing entity (S202). In steps in FIG. 6, simplified descriptions are described.

The network flow control unit 511 reads the multithread number of the i-th layer from the layer processing information table 515 and sets it as a value of s_num (S203).

The network flow control unit 511 divides the subdivided encrypted parameter group of the i-th layer into a range of s_num number of variables from the variable s_num and the subdivided encrypted parameter information 514 (S204). Division of the encrypted parameter group is performed so that the number of subdivided encrypted parameters is divided into s_num number of groups such that the number of each group is equal. When division is not completely equal, the network flow control unit 511 divides so that the difference in the number of parameters of each group is small. For example, when the network flow control unit 511 divides 100 subdivided encrypted parameter groups into a range of 40 (variable s_num = 40), it divides such that there are 20 ranges of 3 subdivided encrypted parameters and 20 ranges of 2 subdivided encrypted parameters. The network flow control unit 511 equally divides the subdivided encrypted parameter group in this way. Thereby, the difference in the number of parameters between groups of each group can be reduced, the end time of each process executed in parallel can be made uniform, and parallel processing can be performed efficiently.

The network flow control unit 511 creates s_num multithreads (S205). The network flow control unit 511 generates multithreads of the CPU 110 when the processing entity is the CPU 110, generates multithreads of the GPU 360 when the processing entity is the GPU 360, and generates multithreads of the FPGA when the processing entity is the FPGA 370.

The network flow control unit 511 inputs, to the j-th thread, the encrypted input data 512 of the i-th layer and the subdivided encrypted parameter group of the j-th range, and executes a function of i-th layer processing in the enclave of the processing entity (S206). In step S206, decryption processing, preprocessing, partial processing, and encryption processing are executed by the selected processing entity.

The i-th layer processing is executed by a process of an enclave generated in the CPU 110, GPU 360, or FPGA 370 in step S202. In step 206, when processing starts, the process proceeds to step S207 without waiting for the end of processing.

The decryption processing unit of the processing entity (decryption processing unit 521 in the case of CPU 110, decryption processing unit 531 in the case of GPU 360, decryption processing unit 541 in the case of FPGA 370) decrypts the input encrypted parameter information 514 and the subdivided encrypted parameter group.

The preprocessing unit of the processing entity (preprocessing unit 522 in the case of CPU 110, preprocessing unit 532 in the case of GPU 360, preprocessing unit 542 in the case of FPGA 370) executes preprocessing by data shaping processing and the like of the i-th layer based on parameters of processing of the i-th layer and the decrypted input data.

The partial processing unit of the processing entity (partial processing unit 523 in the case of CPU 110, partial processing unit 533 in the case of GPU 360, partial processing unit 543 in the case of FPGA 370) executes partial processing of the i-th layer using the subdivided parameters of the i-th layer and data on which preprocessing has been executed. For example, as partial processing, processing of each layer constituting DNN or LLM (Attention processing, Convolution processing, Pooling processing, Dense processing, etc.) is executed. When the partial processing ends, the enclave transmits a processing end notification and pointer information to a processing result in the enclave to the network flow control unit 511.

The network flow control unit 511 adds 1 to the value of variable j (S207), and determines whether the value of variable j is smaller than the value of variable s_num (S208).

When the value of variable j is smaller than the value of variable s_num (S208: YES), the network flow control unit 511 returns to step S206 and executes similar processing. By repeating processing of steps S206 to S208, processing of the i-th layer can be executed in parallel in s_num multithreads. When the value of variable j is equal to or greater than the value of variable s_num (S208: NO), the network flow control unit 511 proceeds to step S209.

In step S209, the network flow control unit 511 waits until it receives all processing end notifications and pointer information to processing results in the enclave for divided processes respectively executed in s_num number of threads of variable s_num in step S205, and when it receives all processing end notifications and pointer information, it proceeds to step S210 (S209).

The network flow control unit 511 instructs the encryption processing unit of the processing entity (encryption processing unit 524 in the case of CPU 110, encryption processing unit 534 in the case of GPU 360, encryption processing unit 544 in the case of FPGA 370) to execute processing to aggregate and encrypt processing results. The encryption processing unit of the processing entity aggregates s_num processing results, encrypts them, and transmits them as an encrypted aggregated processing result to the network flow control unit 511. The network flow control unit 511 sets the encrypted aggregated processing result received from the enclave as output data of the i-th layer (S210).

The network flow control unit 511 deletes the enclave (S211). Thereby, resources of CPU TEE (trusted area 321), GPU TEE (trusted area 362), or FPGA TEE (trusted area 372) with limited capacity can be effectively utilized. When it is more efficient not to delete the enclave than to delete and newly generate the enclave (such as when the same enclave is used in consecutive layers), the enclave need not be deleted (step S211).

In step S212, the network flow control unit 511 adds 1 to the value of variable i (S212). The network flow control unit 511 determines whether the i-th layer exists (S213).

When the i-th layer exists (S213: YES), the network flow control unit 511 sets the encrypted aggregated processing result as encrypted input data 512, returns to step S202, and executes similar processing. When the i-th layer does not exist (S213: NO), the network flow control unit 511 outputs the encrypted aggregated processing result and ends confidential information processing.

### 1-3. Effects of Embodiment 1

As described above, the server 30 can execute processing composed of a plurality of operations of layer processing (block processing) such as DNN or LLM with processing and parallel degree matched to characteristics of a processing entity in TEE (trusted area) of a plurality of processing entities (CPU, GPU, FPGA). Furthermore, since the server 30 performs processing by decrypting data and parameters encrypted by a data holder only within safe TEE, safe data exchange with a plurality of trusted areas and efficient execution are realized, and machine learning applications such as DNN or LLM can be executed safely and at high speed.

The present disclosure is not limited to the above-described embodiments, and various modifications and equivalent configurations within the spirit of the appended claims are included. For example, the above-described embodiments have been described in detail to explain the present invention in an easy-to-understand manner, and are not necessarily limited to those having all the configurations described. Also, additions, deletions, and substitutions of other configurations may be made for part of the configuration of a certain embodiment.

Also, each configuration, function, processing unit, processing means, etc. described above may be realized by hardware by, for example, designing part or all of them with an integrated circuit, or may be realized by software by a processor interpreting and executing a program that realizes each function.

Also, each configuration, function, processing unit, processing means, etc. described above may be realized by hardware by, for example, designing part or all of them with an integrated circuit. Also, the present invention can be realized by program code of software that realizes functions of embodiments. In this case, a storage medium in which the program code is recorded is provided to a computer, and a processor provided in the computer reads out the program code stored in the storage medium. In this case, the program code itself read from the storage medium realizes the functions of the above-described embodiments, and the program code itself and a storage medium storing it constitute the present invention. As a storage medium for supplying such program code, for example, a flexible disk, CD-ROM, DVD-ROM, hard disk, SSD (Solid State Drive), optical disk, magneto-optical disk, CD-R, magnetic tape, non-volatile memory card, ROM, etc. are used.

Also, program code that realizes functions described in the present embodiment can be implemented in a wide range of programs or script languages such as, for example, assembler, C/C++, perl, Shell, PHP, Python, Java (registered trademark).

Furthermore, by distributing program code of software that realizes functions of embodiments via a network, it may be stored in storage means such as a hard disk or memory of a computer or a storage medium such as CD-RW or CD-R, and a processor provided in the computer may read and execute the program code stored in the storage means or the storage medium.

In the above-described embodiments, control lines and information lines show what is considered necessary for explanation, and do not necessarily show all control lines and information lines in a product. All configurations may be mutually connected.

Also, the present invention can obtain similar effects when confidential information with high confidentiality that is restricted from being disclosed outside the company by company rules, etc., such as business secrets in addition to personal information, is kept confidential and provided to external organizations, etc.

And the present invention can improve processing efficiency of advanced Deep Learning, Large Language Model, Generative AI, etc. processing while keeping personal information such as customer information and medical information and confidential information such as business secrets confidential in a plurality of organizations that handle personal information such as customer information and medical information and confidential information such as business secrets, and therefore can be widely applied to information processing systems for public/private services that link diverse confidential information.

The above-described embodiments explicitly disclose inventions with the following configurations.

(Supplementary Note 1) A computer system including at least one computer, wherein the at least one computer has a plurality of processors, memories provided correspondingly to the plurality of processors, and a network interface coupled to the plurality of processors, the plurality of processors have a function for setting a trusted area that is secured in security and logically isolated in a corresponding memory among the plurality of memories, the at least one computer accepts an execution request for processing that includes a plurality of operations of block processing on encrypted data in which data including confidential information is encrypted, when executing one operation of the block processing, sets as a processing entity a predetermined processor designated in the block processing from a plurality of processors, executes the block processing in parallel in the trusted area of the processing entity with a parallel number, based on the processing entity and the parallel number, when each parallel execution ends, aggregates and encrypts each execution result in the trusted area of the processing entity, designates as a next predetermined processor a processor related to block processing to be executed next among the plurality of operations of block processing, and outputs each execution result aggregated to the next predetermined processor.

(Supplementary Note 2) The computer system according to Supplementary Note 1, wherein the plurality of processors include at least one general-purpose processor and at least one processor for specific processing.

(Supplementary Note 3) The computer system according to Supplementary Note 2, wherein the general-purpose processor is at least one of CPU (Central Processing Unit) or MPU (Micro Processing Unit), and the processor for specific processing is at least one of GPU (Graphic Processing Unit), FPGA (Field Programmable Gate Array), and IPU (Infrastructure Processing Unit).

(Supplementary Note 4) The computer system according to Supplementary Note 3, wherein the at least one computer holds a block processing information table that indicates which of the plurality of processors processes the plurality of operations of block processing, and the block processing information table manages, in association with one another, block processing identification information that identifies the plurality of operations of block processing, processing entity identification information that designates a predetermined processor that processes block processing specified by the block processing identification information among the plurality of processors, and a parallel number in the predetermined processor.

(Supplementary Note 5) The computer system according to Supplementary Note 4, wherein the predetermined processor decrypts, in a trusted area provided in a memory corresponding to the predetermined processor among the plurality of memories, each execution result encrypted and output from a processor that processed immediately before the predetermined processor, executes block processing assigned to the predetermined processor among the plurality of operations of block processing, when each parallel execution ends, aggregates and encrypts each execution result in the trusted area corresponding to the predetermined processor, designates as a next predetermined processor a processor related to block processing to be executed next among the plurality of operations of block processing, and outputs each execution result aggregated to the next predetermined processor.

(Supplementary Note 6) The computer system according to Supplementary Note 5, wherein the predetermined processor executes, in the trusted area corresponding to the predetermined processor, processing to decrypt encrypted data, predetermined preprocessing on decrypted data, block processing, which is assigned to the predetermined processor, on the preprocessed data, and processing to encrypt an execution result of each parallel processing of the block processing.

(Supplementary Note 7) An information processing method executed by a computer system, wherein the computer system includes at least one computer, the at least one computer has a plurality of processors, memories provided correspondingly to the plurality of processors, and a network interface coupled to the plurality of processors, the plurality of processors have a function for setting a trusted area that is secured in security and logically isolated in a corresponding memory among the plurality of memories, the information processing method comprising: accepting an execution request for processing that includes a plurality of operations of block processing on encrypted data in which data including confidential information is encrypted; when executing one operation of the block processing setting as a processing entity a predetermined processor designated in the block processing from a plurality of processors, executing the block processing in parallel in the trusted area of the processing entity with the parallel number, based on the processing entity and the parallel number; when each parallel execution ends, aggregating and encrypting each execution result in the trusted area of the processing entity, designating as a next predetermined processor a processor related to block processing to be executed next among the plurality of operations of block processing, and outputting each execution result aggregated to the next predetermined processor.

(Supplementary Note 8) The information processing method according to Supplementary Note 7, wherein the plurality of processors include at least one general-purpose processor and at least one processor for specific processing.

(Supplementary Note 9) The information processing method according to Supplementary Note 8, wherein the general-purpose processor is at least one of CPU (Central Processing Unit) or MPU (Micro Processing Unit), and the processor for specific processing is at least one of GPU (Graphic Processing Unit), FPGA (Field Programmable Gate Array), and IPU (Infrastructure Processing Unit).

(Supplementary Note 10) The information processing method according to Supplementary Note 9, wherein the at least one computer holds a block processing information table that indicates which of the plurality of processors processes the plurality of operations of block processing, and the block processing information table manages, in association with one another, block processing identification information that identifies the plurality of operations of block processing, processing entity identification information that designates a predetermined processor that processes block processing specified by the block processing identification information among the plurality of processors, and a parallel number in the predetermined processor.

(Supplementary Note 11) The information processing method according to Supplementary Note 10, wherein the predetermined processor decrypts, in a trusted area provided in a memory corresponding to the predetermined processor among the plurality of memories, each execution result encrypted and output from a processor that processed immediately before the predetermined processor, executes block processing assigned to the predetermined processor among the plurality of operations of block processing, when each parallel execution ends, aggregates and encrypts each execution result in the trusted area corresponding to the predetermined processor, designates as a next predetermined processor a processor related to block processing to be executed next among the plurality of operations of block processing, and outputs each execution result aggregated to the next predetermined processor.

(Supplementary Note 12) The information processing method according to Supplementary Note 11, wherein the predetermined processor executes, in the trusted area corresponding to the predetermined processor, processing to decrypt encrypted data, predetermined preprocessing on decrypted data, block processing assigned to the predetermined processor on the preprocessed data, and processing to encrypt an execution result of each parallel processing of the block processing.

What is claimed is:

1. A computer system including at least one computer, wherein
the at least one computer has a plurality of processors, memories provided correspondingly to the plurality of processors, and a network interface coupled to the plurality of processors;
the plurality of processors have a function for setting a trusted area that is secured in security and logically isolated in a corresponding memory among the plurality of memories;
the at least one computer:
accepts an execution request for processing that includes a plurality of operations of block processing on encrypted data in which data including confidential information is encrypted;
when executing one operation of the block processing, sets as a processing entity a predetermined processor designated in the block processing from the plurality of processors, executes the block processing in parallel in the trusted area of the processing entity with a parallel number, based on the processing entity and the parallel number;
when each parallel execution ends, aggregates and encrypts each execution result in the trusted area of the processing entity, designates as a next predetermined processor a processor related to block processing to be executed next among the plurality of operations of block processing, and outputs each execution result aggregated to the next predetermined processor.

2. The computer system according to claim 1, wherein the plurality of processors include at least one general-purpose processor and at least one processor for specific processing.

3. The computer system according to claim 2, wherein the general-purpose processor is at least one of CPU (Central Processing Unit) or MPU (Micro Processing Unit), and the processor for specific processing is at least one of GPU (Graphic Processing Unit), FPGA (Field Programmable Gate Array), and IPU (Infrastructure Processing Unit).

4. The computer system according to claim 3, wherein the at least one computer holds a block processing information table that indicates which of the plurality of processors processes the plurality of operations of block processing, and the block processing information table manages, in association with one another, block processing identification information that identifies the plurality of operations of block processing, processing entity identification information that designates a predetermined processor that processes block processing specified by the block processing identification information among the plurality of processors, and a parallel number in the predetermined processor.

5. The computer system according to claim 4, wherein the predetermined processor:
decrypts, in a trusted area provided in a memory corresponding to the predetermined processor among the plurality of memories, each execution result encrypted and output from a processor that processed immediately before the predetermined processor;
executes block processing assigned to the predetermined processor among the plurality of operations of block processing;
when each parallel execution ends, aggregates and encrypts each execution result in the trusted area corresponding to the predetermined processor, designates as a next predetermined processor a processor related to block processing to be executed next among the plurality of operations of block processing, and outputs each execution result aggregated to the next predetermined processor.

6. The computer system according to claim 5, wherein the predetermined processor executes, in the trusted area corresponding to the predetermined processor, processing to decrypt encrypted data, predetermined preprocessing on decrypted data, block processing, which is assigned to the predetermined processor, on the preprocessed data, and processing to encrypt an execution result of each parallel processing of the block processing.

7. An information processing method executed by a computer system, wherein
the computer system includes at least one computer;
the at least one computer has a plurality of processors, memories provided correspondingly to the plurality of processors, and a network interface coupled to the plurality of processors;
the plurality of processors have a function for setting a trusted area that is secured in security and logically isolated in a corresponding memory among the plurality of memories;
the information processing method comprising:
accepting an execution request for processing that includes a plurality of operations of block processing on encrypted data in which data including confidential information is encrypted;
when executing one operation of the block processing, setting as a processing entity a predetermined processor designated in the block processing from the plurality of processors as a processing entity, executing the block processing in parallel in the trusted area of the processing entity with a parallel number, based on the processing entity and the parallel number;
when each parallel execution ends, aggregating and encrypting each execution result in the trusted area of the processing entity, designating as a next predetermined processor a processor related to block processing to be executed next among the plurality of operations of block processing, and outputting each execution result aggregated to the next predetermined processor.

8. The information processing method according to claim 7, wherein the plurality of processors include at least one general-purpose processor and at least one processor for specific processing.

9. The information processing method according to claim 8, wherein the general-purpose processor is at least one of CPU (Central Processing Unit) or MPU (Micro Processing Unit), and the processor for specific processing is at least one of GPU (Graphic Processing Unit), FPGA (Field Programmable Gate Array), and IPU (Infrastructure Processing Unit).

10. The information processing method according to claim 9, wherein the at least one computer holds a block processing information table that indicates which of the plurality of processors processes the plurality of operations of block processing, and the block processing information table manages, in association with one another, block processing identification information that identifies the plurality of operations of block processing, processing entity identification information that designates a predetermined processor that processes block processing specified by the block processing identification information among the plurality of processors, and a parallel number in the predetermined processor.

11. The information processing method according to claim 10, wherein the predetermined processor:
decrypts, in a trusted area provided in a memory corresponding to the predetermined processor among the plurality of memories, each execution result encrypted and output from a processor that processed immediately before the predetermined processor;
executes block processing assigned to the predetermined processor among the plurality of operations of block processing;
when each parallel execution ends, aggregates and encrypts each execution result in the trusted area corresponding to the predetermined processor, designates as a next predetermined processor a processor related to block processing to be executed next among the plurality of operations of block processing, and outputs each execution result aggregated to the next predetermined processor.

12. The information processing method according to claim 11, wherein the predetermined processor executes, in the trusted area corresponding to the predetermined processor, processing to decrypt encrypted data, predetermined preprocessing on decrypted data, block processing assigned to the predetermined processor on the preprocessed data, and processing to encrypt an execution result of each parallel processing of the block processing.
